(19) United States
(12) Patent Application Publication
(10) Pub. No.: US 2025/0315711 A1
(43) Pub. Date: Oct. 9, 2025

(54) QUANTUM MACHINE LEARNING METHOD FOR MULTI-CLASS CLASSIFICATION

(71) Applicant: Korea University Research and Business Foundation, Seoul (KR)

(72) Inventors: Joongheon KIM, Seoul (KR); Han-Kyul BAEK, Seoul (KR); SooHyun PARK, Incheon (KR)

(21) Appl. No.: 18/908,735

(22) Filed: Dec. 19, 2024

(30) Foreign Application Priority Data
Oct. 6, 2023 (KR) 10-2023-0133680

(51) Int. Cl. G06N 10/60

(52) U.S. Cl. CPC G06N 10/60

(57) ABSTRACT

The present invention relates to a quantum machine learning method for multi-class classification, and the method comprises the steps of: applying a Quantum Convolution Neural Network (QCNN) quantum circuit to input data having q qubits, and outputting a feature vector based on Pauli-Z measurement; and applying a Quantum Neural Network (QNN) quantum circuit to the feature vector, and outputting a multi-class prediction vector with scalability increased compared to q qubits based on basis measurement.

### CROSS REFERENCE TO RELATED APPLICATIONS

This application claims priority to Korean Patent Application No. 10-2023-0133680, filed on Oct. 6, 2023, in the Korean Intellectual Property Office, the disclosure of which is incorporated by reference herein in its entirety.

### BACKGROUND

### Field

The present invention relates to a quantum machine learning method for multi-class classification.

### Background of the Related Art

Quantum neural networks (QNN) based on quantum computing attract attention recently due to the potential for computational acceleration and parallelization. The quantum computing is a method of obtaining information (1 or 0) by measuring the state of quantum bits (qubits), which is a technique that can solve, within a determined time, problems that cannot be solved by conventional classical computing.

In recent years, quantum machine learning (QML) using quantum computing is actively used for various tasks such as classification, reinforcement learning, and adversarial learning. However, these quantum machine learning techniques have following disadvantages compared to classical machine learning techniques.

First, the incapability of quantum machine learning that may not perform complex tasks due to the scalability problem of input and output has been pointed out as a major limitation. That is, since conventional quantum machine learning techniques should use the same dimension of an input qubit and an output qubit (q) and learn a gradient of 2q×2q to learn a quantum circuit on a classical computer, a very large amount of computation is required. Accordingly, studies on the quantum machine learning have been conducted focusing on binary classification.

Second, conventional quantum machine learning has a problem of low performance. For example, in the case of using data of the Modified National Institute of Standards and Technology database (MNIST), the accuracy is over 99% when classical machine learning is used, but the accuracy is known to be only 32.5% when learning is conducted using the MNIST data as is in the quantum machine learning.

Third, the quantum machine learning has a problem of trainability. That is, since quantum circuits or quantum computers are difficult to train, there is a problem in that the quantum machine learning is not learned well.

### SUMMARY OF THE INVENTION

Therefore, the present invention has been made in view of the above problems, and an object of the present invention is to provide a quantum machine learning method for multi-class classification.

To accomplish the above object, according to one aspect of the present invention, there is provided a quantum machine learning method for multi-class classification, and the method comprises the steps of: applying a Quantum Convolution Neural Network (QCNN) quantum circuit to input data having q qubits, and outputting a feature vector based on Pauli-Z measurement; and applying a Quantum Neural Network (QNN) quantum circuit to the feature vector, and outputting a multi-class prediction vector with scalability increased compared to q qubits based on basis measurement.

### BRIEF DESCRIPTION OF THE DRAWINGS

FIG. 1 is a view for explaining Pauli-Z measurement and basis measurement on qubits.

FIG. 2 is a view showing the entire process of quantum machine learning for multi-class classification according to an embodiment of the present invention.

FIG. 3 is a view showing feature vector output through the initial QCNN in FIG. 2.

FIG. 4 is a view showing feature vector output through an additional QCNN in FIG. 2.

FIG. 5 is a view showing prediction vector output through QNN in FIG. 2.

FIG. 6A is a graph showing the learning curve of MNIST data set used for performance test of quantum machine learning according to an embodiment of the present invention.

FIG. 6B is a graph showing the learning curve of FashionMNIST data set used for performance test of quantum machine learning according to an embodiment of the present invention.

FIG. 6C is a graph showing the learning curve of CIFAR10 data set used for performance test of quantum machine learning according to an embodiment of the present invention.

FIG. 6D is a graph showing the learning curve of EMNIST-letters data set used for performance test of quantum machine learning according to an embodiment of the present invention.

FIG. 7A is a graph showing performance comparison between quantum machine learning and QuantumNAS according to an embodiment of the present invention.

FIG. 7B is a graph showing a result of comparing performance of quantum machine learning according to an embodiment of the present invention and a case where a probability amplitude regularizer is removed.

### DETAILED DESCRIPTION OF THE PREFERRED EMBODIMENT

The detailed description of the present invention described below refers to the accompanying drawings which show specific embodiments in which the present invention may be practiced as an example. These embodiments are described in sufficient detail so that those skilled in the art may practice the present invention. It should be understood that various embodiments of the present invention do not necessarily need to be mutually exclusive although they are different from one another. For example, specific shapes, structures, and characteristics described herein may be implemented in other embodiments without departing from the spirit and scope of the present invention. In addition, it should be also understood that the positions or arrangements of individual components within each disclosed embodiment may be changed without departing from the spirit and scope of the present invention. Accordingly, the detailed description described below is not to be taken in a limiting sense, and when properly described, the scope of the present invention is limited only by the appended claims together with all scopes equivalent to those asserted by the claims. Like reference numerals in the drawings designate the same or similar functions throughout the several aspects.

The components according to the present invention are components defined by functional classification rather than physical classification, and may be defined by the functions performed by each component. Each of the components may be implemented as hardware or a program code and processing unit that performs each of the functions, and the functions of two or more components may be implemented to be included in one component. Therefore, the names given to the components in the following embodiments are not to physically distinguish each component, but to imply a representative function performed by each component, and it should be noted that the technical spirit of the present invention is not limited by the names of the components.

Before describing the embodiments of the present invention, the notations to be used in this specification are defined as follows.

Notation Θ={θ^{enc}; θ^{PQC}} is used for trainable parameters.

ζ [symbol] {(X, y)} is defined as a sampled mini-batch, where X and y represent a sampled input data and a corresponding label of the mini-batch, respectively.

Label

$$y {=}^{Δ} {\{ {y}_{n} \}}_{n = 1}^{\vert y \vert}$$

is a one-hot vector where yₙ=1 in the case where the true label is n∈N[1,|y|], and the other elements are 0.

Extracted features are denoted as \hat{X}, and Dirac notation is used to express the quantum state and its operation.

In addition, operators (⋅)+ and ⊗ represent the complex conjugate transpose and the tensor product, respectively.

Two terms Q and q are separately used to denote a Q-qubit system that encodes classical data and a q-qubit system that performs prediction.

The Q qubit quantum state is defined as shown below in equation 1.

$$\vert ψ 〉 = {\sum }_{n = 1}^{{2}^{Q}} {α}_{n} \vert n 〉 \qquad [ Equation 1 ]$$

Here, αₙ and ln> represent the probability amplitude and the n-th basis in the Hilbert space, respectively.

According to the definition of the Hilbert space (i.e., [symbol] ^{⊗Q}= [symbol] ²^{^{Q}}, the probability amplitude ∀αₙ∈C satisfies the following formula, i.e.,

$${\sum }_{n = 1}^{{2}^{Q}} {\vert {α}_{n} \vert}^{2} = 1 .$$

Hereinafter, preferred embodiments of the present invention will be described in more detail with reference to the drawings.

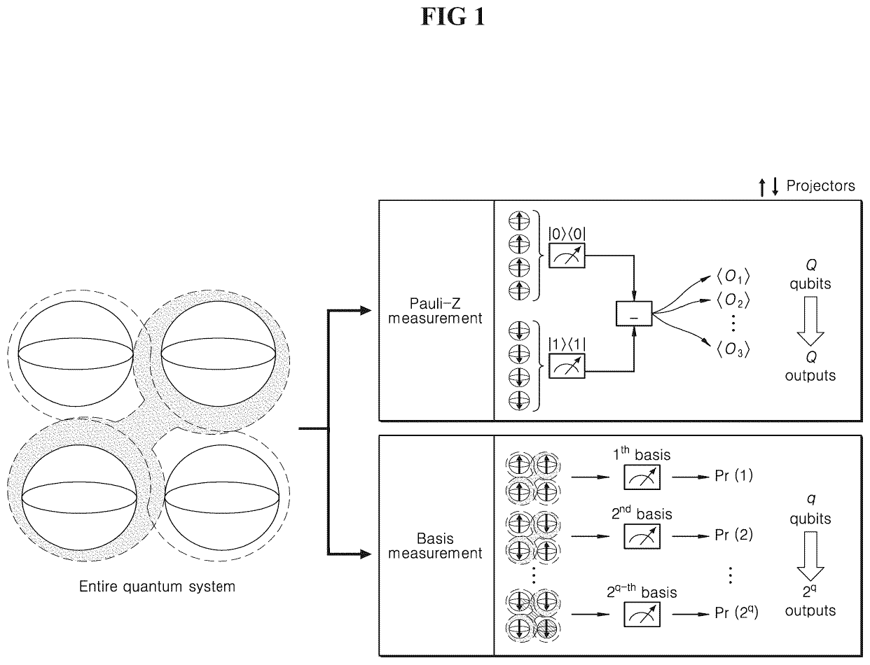

FIG. 1 is a view for explaining Pauli-Z measurement and basis measurement on qubits.

There are largely two types of quantum circuits used in the embodiments of the present invention, and one is a Quantum Convolution Neural Network (QCNN) quantum circuit, and the other is a QNN quantum circuit.

The qubits shown on the left side of FIG. 1 represent a state in which qubits are overlapped and entangled with each other in a quantum system, and there is a characteristic in that when a state in which four qubits are entangled is assumed as shown in the drawing, the four qubits exhibit mutual dependency, and when the state of one qubit changes, the states of the remaining three qubits also change simultaneously. The four qubits shown in FIG. 1 are shown as an example, and the number of qubits is not limited thereto.

Quantum measurement is a type of decoding process that enables utilization of quantum computing in the area of classical computation, particularly in the field of data-based QNN. Here, an observation value (i.e., output) obtained through individual measurements in the quantum system is not deterministic but inherently probabilistic. Therefore, the basic strategy of QNN relies on calculation or expectation of statistical probabilities derived from several measurement shots.

The upper right of FIG. 1 shows the Pauli-Z measurement method most widely used in QNN, and the lower right shows the basis measurement method with increased scalability of output proposed in the present invention.

Describing the Pauli-Z measurement method first, the Pauli-Z measurement method measures the quantum state of an individual qubit with Pauli-Z matrix

$$Z = [ \begin{matrix}1 & 0 \\ 0 & - 1\end{matrix} ] ,$$

where each column of matrix Z represents computational basis |\tilde{1} [symbol] , |\tilde{0} [symbol] . Therefore, when the input of the Pauli-Z measurement method has Q dimensions, a Q-dimensional output is obtained.

To calculate an expectation of individual qubits, a projector matrix may be designed as

$${P}_{Z}^{n} {=}^{Δ} {I}^{⊗ n - 1} ⊗ Z ⊗ {I}^{⊗ Q - n} ,$$

where I and Q denote the identity matrix and the number of qubits in the target quantum system, respectively.

Therefore, the observation value obtained through Pauli-Z measurement may be calculated through equation 2 shown below.

$$〈 {O}_{n} 〉 = 〈 ψ \vert {P}_{Z}^{n} \vert ψ 〉 \qquad [ Equation 2 ]$$

Here, the individual expectation value of the observation value is Oₙ∈R[−1, 1] when ∀n∈N[1, Q].

As shown in Equation 2, the Pauli-Z measurement determines an expectation value of an individual qubit. That is, when a qubit is highly likely to be in state |\tilde{0} [symbol] , the expectation value <Oₙ> is greater than 0, and when the qubit is highly likely to be in state |\tilde{1} [symbol] , the expectation value is smaller than 0.

The Pauli-Z measurement method is suitable to be applied to feature extraction tasks since the range of individual expectation values of observation values is not directly limited by other results in this way. However, the Pauli-Z measurement method is not suitable for multi-classification tasks since the scale is limited by the number of qubits.

Describing the basis measurement method next, in contrast to the Pauli-Z measurement that considers individual measurements on two computational bases, the basis measurement measures the entire quantum system for all possible 2^{q} bases. Therefore, when the input is q-dimensional, the basis measurement method obtains a 2^{q}-dimensional output.

The basis measurement measures a probability value by projecting individual qubits onto a projector {|n [symbol] (n|}ₙ₌₁²^{²}, and the output may be expressed as shown below in equation 3.

$$P {r}_{Basis} ( y = n ) = 〈 ψ \vert n 〉 〈 n \vert ψ 〉 = {\vert ψ \vert n \vert}^{2} = {\vert {α}_{n} \vert}^{2} \qquad [ Equation 3 ]$$

Here, αₙ denotes the n-th amplitude of a corresponding basis in the quantum state |ψ> shown in equation 1 and therefore may be expressed as Σₙ₌₁²^{^{Q}}, Pr_{Basis}(y=n)=1. The probability value measured here may be utilized as an activation function such as the softmax function.

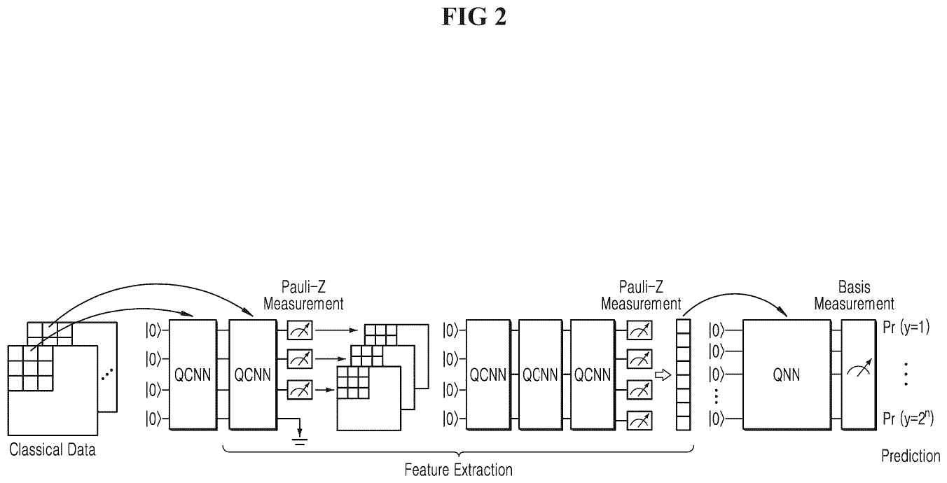

In an embodiment of the present invention, the Pauli-Z measurement is used for image processing using QCNN, and the basis measurement is used for classification using QNN, and hereinafter, quantum machine learning for multi-class classification according to an embodiment of the present invention will be described with reference to FIG. 2.

FIG. 2 is a view showing the entire process of quantum machine learning for multi-class classification according to an embodiment of the present invention.

The quantum machine learning framework for multi-class classification shown in FIG. 2 is basically configured of QCNN and QNN, and the structure of QCNN/QNN is configured of three parts including state encoding, linear transformation via parameterized quantum circuits (PQCs), and measurement.

First, since the classical input size is larger than the number of qubits, data is reuploaded for the state encoder. In order to successfully encode classical input data X, X is partitioned into [x₁; . . . ; x_{Cin}]. The partitioned classical data is encoded into a probability amplitude, and the encoding process may be expressed as shown below in equation 4.

$$\vert {ψ}_{e n c} 〉 = U ( {θ}_{{c}_{i n}} ) U ( {x}_{{c}_{i n}} ) … U ( {θ}_{1} ) U ( {x}_{{x}_{1}} ) \vert {ψ}_{0} 〉 \qquad [ Equation 4 ]$$

Here, |ψ₀ [symbol] denotes the initial quantum state, e.g., the first standard basis for 2^{Q}-dimensional vectors, ∀θ_{c}⊂θ_{anc}, and ∀c∈N[1, cᵢₙ].

The encoded state |ψ_{enc} [symbol] is processed by PQC, where the result is expressed as |+ψ_{PQC} [symbol] =U(θ^{PQC})|ψ_{enc} [symbol] , and the processed quantum state |ψ_{PQC} [symbol] is measured in the Pauli-Z measurement method of QCNN and the basis measurement method of QNN, respectively.

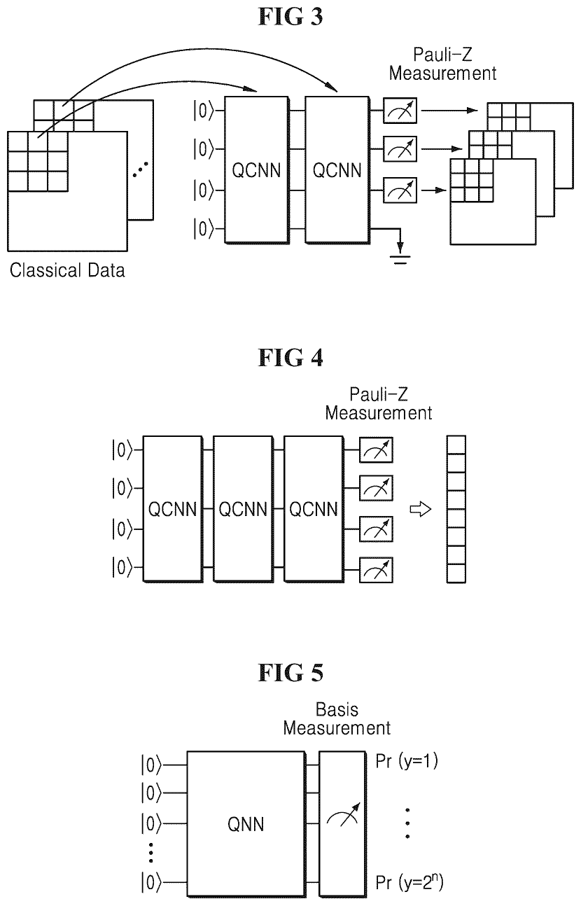

In the embodiments of the present invention described below, each process presented in FIG. 2 will be described in more detail with reference to FIGS. 3 to 5.

FIG. 3 is a view showing feature vector output through the initial QCNN in FIG. 2, and FIG. 4 is a view showing feature vector output through an additional QCNN in FIG. 2.

Each input data, which is classical data, corresponds to a channel, and a 2D grid of the input data represents a patch in each channel. The input data may be image data. When measuring a quantum state in QCNN, the predicted value of projection for each qubit means the value of the output channel.

Describing the feature vector output through the initial QCNN with reference to FIG. 3, the QCNN quantum circuit is applied to input data having q qubits, and the feature vector is output based on the Pauli-Z measurement that measures on the basis of two computational bases. That is, an image is input as input data through each of a plurality of input channels, and an initial feature vector is extracted based on the Pauli-Z measurement.

Describing the feature vector output through an additional QCNN with reference to FIG. 4, a QCNN quantum circuit is applied to the initial feature vector output through the initial QCNN, and a higher-level feature vector is output by further abstracting the feature vector based on the Pauli-Z measurement. That is, a feature vector having q qubits is extracted for each input channel. At this point, the additional QCNN includes one or more QCNN layers, and the feature vector output by each QCNN layer based on the Pauli-Z measurement is input into the next QCNN layer.

The input of the QCNN quantum circuit described in FIG. 3 and FIG. 4 has the shape W×H×cᵢₙ, and Ŵ and Ĥ vary according to kernel size k, stride s, and padding d. That is, Ŵ=(W+d)/s and Ĥ=(H+d)/s. Each patch of the input is feed-forwarded to the QCNN by a data re-upload method, and pooling of the QCNN is performed by a measurement process. The n-th expectation value of observation value <Oₙ> corresponds to the scalar value of the n-th channel, and the output has a form of Ŵ×Ĥ×cₒᵤₜ.

The computational complexity of the QNN in each layer is [symbol] (Ŵ·Ĥ·k²·cᵢₙ), where k denotes the kernel size. On the contrary, the computational complexity of the classical CNN is [symbol] (Ŵ·Ĥ·k²·cᵢₙ·cₒᵤₜ). The input and output channels of the QCNN are scalable under the constraint condition of ∀cᵢₙ, cₒᵤₜ ∈N[1, Q].

FIG. 5 is a view showing prediction vector output through QNN in FIG. 2.

Describing the prediction vector output through QNN, the QNN quantum circuit is applied to the feature vector extracted through QCNN, and a multi-class prediction vector with scalability increased compared to q qubit data (input data) is output based on the basis measurement that measures all possible bases of the entire quantum system. That is, the feature vector is input into the QNN quantum circuit, and a probability value, which is a 2^{q}-dimensional observation value (observable), is output as a probability measurement for the multi-class prediction vector on the basis of the basis measurement.

The multi-class probability value is predicted based on the amplitude of corresponding basis in the entire quantum system, and the dimension of the multi-class probability value is extended to satisfy the number of classes according to the classification purpose.

Describing in more detail, the number of classes lyl is generally larger than the number of qubits q. However, there is a problem in that when the number of qubits increases, QCNN/QNN is difficult to train. Therefore, the Pauli-Z measurement shown in Equation 2 described above is limitedly applied only to simple multi-class classification (e.g., binary classification of a 2-qubit system or 4-class classification of a 4-qubit system).

Therefore, in order to extend the application of the quantum computing to complex multi-class classification, the embodiment of the present invention proposes a QNN based on basis measurement. Features extracted in a way similar to QCNN processing are encoded through equation 4 described above.

Then, when the quantum state |ψ [symbol] is projected onto a pure density matrix, i.e., {|1 [symbol] 1|, . . . , |n [symbol] n|, . . . , |2 [symbol] 2^{q}|}, a probability for the observation value of 24 may be obtained. At this point, the probability of the n-th class may be expressed as shown below in equation 5.

$$Pn = P r ( y = n \vert X ; Θ ) = {\vert {α}_{n} \vert}^{2} \qquad [ Equation 5 ]$$

The QNN based on basis measurement according to an embodiment of the present invention does not need a softmax function for prediction using logits since the probability amplitude an is directly mapped to the probability of class n, and also does not need a softmax temperature coefficient.

Meanwhile, the framework of the quantum machine learning for multi-class classification according to an embodiment of the present invention includes a new regularizer as described below to reduce performance degradation due to the errors generated by the probability of unused classes. In particular, objective functions are configured as shown below in Equations 6 and 7 as a binary cross-entropy function L_{BCE} and a probability amplitude regularizer L_{PAR} for the probability of unused class indices.

$${ℒ}_{BCE} ( Θ ; X ) = - {\sum }_{n = 1}^{\vert y \vert} [ {y}_{c} log {p}_{c} + ( 1 - {y}_{c} ) log ( 1 - {p}_{c} ) ] \qquad [ Equation 6$$

$${ℒ}_{PAR} ( Θ ; X ) = - {\sum }_{{n}^{′} > \vert y \vert}^{{2}^{q}} log ( 1 - {p}_{{n}^{′}} ) \qquad [ Equation 7 ]$$

Here, q≥┌log₂(|y|)┐, and therefore, the train loss function for a one-step single update may be finally defined as shown below in equation 8.

$$ℒ ( Θ ; ζ ) = \frac{1}{\vert ζ \vert} {\sum }_{( X , y ) ∈ ζ} [ {ℒ}_{BCE} ( Θ ; X ) + {ℒ}_{PAR} ( Θ ; X ) ] \qquad [ Equation 8 ]$$

Next, the gradient of the train loss function may be obtained as follows.

Since quantum computers may not use a classical training method (e.g., back-propagation using a chain rule), zero-order optimization is used to estimate the gradient, which is referred to as a parameter shifting rule.

The loss gradient may be obtained as shown below in the equation 9 by calculating the symmetric difference quotient of loss L.

$$\frac{\partial ℒ ( Θ ; ζ )}{\partial {θ}_{m}} = \frac{\partial ℒ ( Θ ; ζ )}{\partial f ( Θ ; ζ )} \cdot \frac{\partial f ( Θ ; ζ )}{\partial {θ}_{m}} , \qquad [ Equation 9 ]$$

$$s . t . \frac{\partial f ( Θ ; ζ )}{\partial {θ}_{m}} = f ( Θ + \frac{π}{2} {e}_{m} ; ζ ) - f ( Θ - \frac{π}{2} {e}_{m} ; ζ )$$

Here, f(Θ;ζ) represents the output of QNN, eₘ is a one-hot vector that removes all elements except Θₘ, i.e., Θ·eₘ=∝ₘ and ∀m∈ [symbol] [1,|Θ|]. Finally, the trainable parameters of the framework of the quantum machine learning for multi-class classification according to an embodiment of the present invention are updated as Θ←Θ−η∀_{Θ} [symbol] (Θ), where η represents the learning rate.

Since learning is performed simultaneously from the beginning to the end in the framework presented in FIG. 2, parameters of QNN, as well as those of QCNN preceding it, are learned together. Accordingly, the probability amplitude regularizer is also applied to the entire FIG. 2.

Table 1 shown below is an example of data sets used for performance test in a quantum machine learning process for multi-class classification presented in FIG. 2.

TABLE 1

| Dataset | Input size | # of class | # of qubits (q) |
|---|---|---|---|
| MNIST | 28 × 28 × 1 | 10 | 4 |
| FashionMNIST | 28 × 28 × 1 | 10 | 4 |
| CIFAR10 | 32 × 32 × 3 | 10 | 4 |
| EMNIST-letter | 28 × 28 × 1 | 26 | 6 |

The effect of probability amplitude regularization is investigated through trainability and performance evaluation of the quantum machine learning process for multi-class classification according to an embodiment of the present invention using various datasets, i.e., MNIST, Fashion MNIST, CIFAR10, and EMNIST-letters datasets. In addition, a benchmark is conducted on training accuracy, test accuracy, comparison with existing QNN frameworks, and ablation of the regularizer.

Two QCNN quantum circuits are used for image processing, and it is assumed that 4×4 kernels are typically used with stride s=3, and a kernel has 3 channels. In addition, four qubits and a controlled unitary gate are used for all quantum circuits (e.g., QNN, QCNN), and for simplicity, an ideal noise-free quantum computing environment that may prevent non-interference in a quantum state and may also have a sufficient number of shots is assumed. The hyperparameters used in the performance test are as follows. That is, it is 8×10⁻³ in the case of initial learning rate and 1,024 in the case of batch size. All experiments on the proposed quantum machine learning framework are performed on a classical computer using Python v3.8.10 and Torch Quantum.

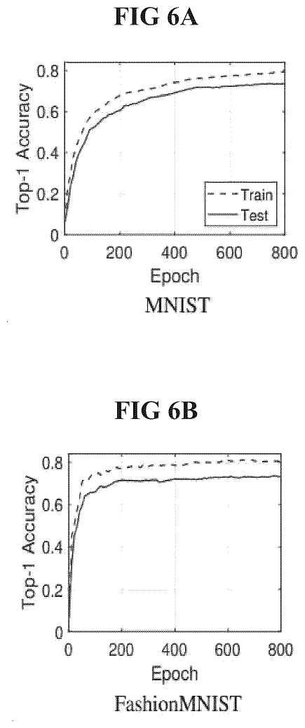

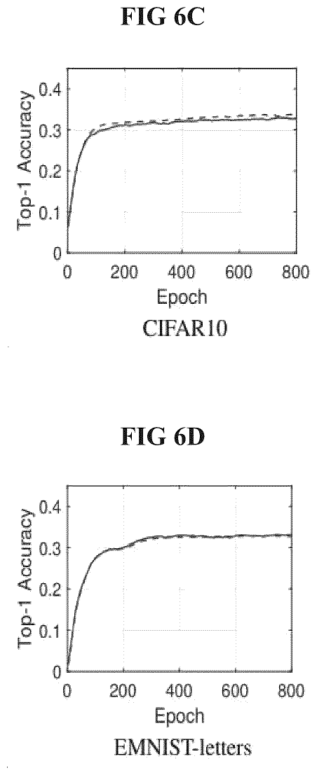

FIG. 6A is a graph showing the learning curve of MNIST data set used for performance test of quantum machine learning according to an embodiment of the present invention, FIG. 6B is a graph showing the learning curve of FashionMNIST data set used for performance test of a quantum machine learning method according to an embodiment of the present invention, FIG. 6C is a graph showing the learning curve of CIFAR10 data set used for performance test of a quantum machine learning method according to an embodiment of the present invention, and FIG. 6D is a graph showing the learning curve of EMNIST-letters data set used for performance test of a quantum machine learning method according to an embodiment of the present invention.

The final performance test of quantum machine learning for multi-class classification according to an embodiment of the present invention has been performed as shown in FIGS. 6A to 6D using data sets of MNIST, FashionMNIST, CIFAR10, and EMNIST-letters presented in Table 1.

In FIG. 6A, it can be confirmed that the test accuracy on the MNIST data set increases from 6.25% to 74.2%, and the domain gap between the training set and the test set is 5.7% between the top-1 accuracies.

In FIG. 6B, it can be confirmed the test accuracy on the FashionMNIST dataset increases from 6.25% to 73.8%, and the domain gap between the training set and the test set is 6.8% between the top-1 accuracies.

In FIGS. 6C and 6D, it can be confirmed the top-1 accuracies for CIFAR10 and EMNIST-letters datasets are 34.4% and 33.1%, respectively, and the domain gap between the training set and the test set is lower than those of the MNIST and FashionMNIST datasets.

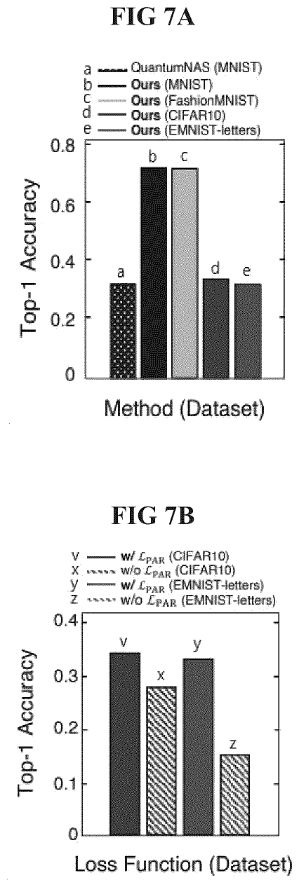

FIG. 7A is a graph showing performance comparison between quantum machine learning and QuantumNAS according to an embodiment of the present invention.

A MNIST image of a size 6×6 is assumed as the input, and it is assumed that QuantumNAS benchmarks the framework with the original size of the dataset as shown in Table 1, without considering quantum noise although the quantum noise exists in the quantum device that is in use.

The graph shown in the drawing compares performance of the quantum machine learning framework according to an embodiment of the present invention with the state-of-the-art (SOTA). The SOTA utilizes the Pauli-Z method described above as the QuantumNAS, and is expressed as bar a on the leftmost side in FIG. 7A, and bar b on the immediate right side shows the performance test result of the present embodiment. In addition, it can be confirmed that the results of the test of the present embodiment performed on other more complex data sets (bars c, d, e) shown on the right side also show higher performance compared to the SOTA.

As shown in FIG. 7A, it can be confirmed that the quantum machine learning framework (Ours) according to an embodiment of the present invention outperforms Quantum NAS by 44.2% in relation to the top-1 accuracy to which the MNIST data set is given. In addition, the quantum machine learning framework according to an embodiment of the present invention is benchmarked using various datasets that use qubits smaller than 7, i.e., FashionMNIST, CIFAR10, and EMNIST-letters, whereas QuantumNAS should use 10 qubits. In this way, the basis measurement may achieve accuracy higher than that of other QNN frameworks, in addition to allowing multi-class classification.

FIG. 7B is a graph showing a result of comparing performance of a quantum machine learning method according to an embodiment of the present invention and a case where a probability amplitude regularizer is removed.

A case of applying the probability amplitude regularizer described above in FIG. 7B and a case of not applying the probability amplitude regularizer have been trained using datasets CIFER10 and EMNIST-letters. As a result, in the case of EMNIST-letters, an improvement of performance as high as 18% can be obtained as the difference of performance as shown in FIG. 7B (see y and z).

As shown in FIG. 7B, the top-1 accuracy of the training method using L_{PAR} is improved by 7.5% in the case of CIFAR10 (v) compared to the case where no regularizer is used (x), and by 17.8% in the case of EMNIST-letters (y) compared to the case where no regularizer is used (z). These results are obtained since prediction of other used labels is reduced through the probability amplitude regularizer, and therefore, it can be confirmed that the regularizer applied in the present invention has an important effect on the quantum machine learning framework for multi-class classification.

The quantum machine learning method for multi-class classification of the present invention as described above may be implemented in the form of program instructions that can be executed through various computer components and may be recorded on a computer-readable recording medium. The computer-readable recording medium may store program instructions, data files, data structures, and the like individually or in combination.

The program instructions recorded on the computer-readable recording medium may be specially designed and configured for the present invention or may be known and available to those skilled in the art in the computer software field.

Examples of the computer-readable recording medium include magnetic media such as hard disks, floppy disks, and magnetic tape, optical recording media such as CD-ROMs and DVDs, magneto-optical media such as floptical disks, and hardware devices specifically configured to store and execute the program instructions, such as ROM, RAM, and flash memory.

Examples of the program instructions include high-level language codes that can be executed by a computer using an interpreter or the like, as well as machine language codes such as those generated by a compiler. The hardware device may be configured to operate as one or more software modules to perform processing according to the present invention, and vice versa.

According to one aspect of the present invention described above, as a quantum machine learning method for multi-class classification is provided, the problem of limiting the number of qubits, in which quantum errors are getting more severe as the number of qubits increases in a quantum circuit, can be solved by utilizing Pauli-Z measurement and basis measurement, and an accuracy improvement of about 40% or more compared to the state-of-the-art can be achieved with a smaller number of qubits.

In addition, as quantum machine learning is performed using a basis measurement method in which the input dimension and output dimension have a relation of output=2^{input}, it has an advantage of reducing the number of qubits to a maximum of [log 2(q)] compared to conventional techniques and also improving learning performance.

Although various embodiments of the present invention have been illustrated and described above, the present invention is not limited to the specific embodiments described above, and various modifications may be made by those skilled in the art without departing from the gist of the present invention as claimed in the claims. Furthermore, such modifications should not be individually understood from the technical idea or prospect of the present invention.

1. A quantum machine learning method, the method comprising:
applying a Quantum Convolution Neural Network (QCNN) quantum circuit configured to input data having q qubits, and outputting a feature vector based on Pauli-Z measurement; and
applying a Quantum Neural Network (QNN) quantum circuit to the feature vector, and outputting a multi-class prediction vector with greater scalability than q qubits based on basis measurement.

2. The method of claim 1, wherein the outputting a multi-class prediction vector inputs the feature vector into the QNN quantum circuit, and outputs a 2^{q}-dimensional observation value as a probability measurement for the multi-class prediction vector based on the basis measurement.

3. The method of claim 1, wherein the outputting a feature vector comprises:
receiving an image as the input data through a plurality of input channels as an input, and outputting an initial feature vector based on the Pauli-Z measurement; and
receiving the initial feature vector as an input, and outputting a feature vector having q qubits for each input channel based on the Pauli-Z measurement.

4. The method of claim 3, further comprising: including one or more QCNN layers, and inputting an initial feature vector output by each QCNN layer based on the Pauli-Z measurement into a next QCNN layer.

5. The method of claim 1, wherein a probability amplitude regularizer is used as a loss function in learning the QNN quantum circuit, and a probability amplitude normalizer L_{PAR} is configured to remove probability values for classes that are not used in learning the QNN quantum circuit, based on the following equation:
$${ℒ}_{P A R} ( Θ ; X ) = - {\sum }_{{n}^{′} > \vert y \vert}^{{2}^{q}} log ( 1 - {p}_{{n}^{′}} ) ,$$
q≥┌log₂(|y|)┐, |y| is the number of classes of a task to be classified, 2^{q} is an output of QNN, Θ is trainable parameters, X is extracted features, and Pn′ is an n′-th projection matrix.

6. The method of claim 5, wherein a binary cross-entropy loss and a probability amplitude regularizer are used as loss functions in learning the QCNN quantum circuit and the QNN quantum circuit, and the binary cross-entropy loss L_{BCE} is defined as shown in the following equation:
$${ℒ}_{BCE} ( Θ ; X ) = - {\sum }_{n = 1}^{\vert y \vert} [ {y}_{c} log {p}_{c} + ( 1 - {y}_{c} ) log ( 1 - {p}_{c} ) ] ,$$
y_{c} and p_{c}
denote the one-hot encoded class label and the predicted probability, respectively.

7. The method of claim 6, wherein a train loss function for one-step single update is defined as shown in the following equation:
$$ℒ ( Θ ; ζ ) = \frac{1}{\vert ζ \vert} {\sum }_{( X , y ) ∈ ζ} [ {ℒ}_{BCE} ( Θ ; X ) + {ℒ}_{PAR} ( Θ ; X ) ] ,$$
wherein ζ denotes a set of sampled mini-batch, consisting of the data X and the label y.
